(19) United States
(12) Patent Application Publication
(10) Pub. No.: US 2015/0199084 A1
(43) Pub. Date: Jul. 16, 2015

(54) METHOD AND APPARATUS FOR ENGAGING AND MANAGING USER INTERACTIONS WITH PRODUCT OR SERVICE NOTIFICATIONS

(71) Applicant: Verizon Patent and Licensing Inc., Basking Ridge, NJ (US)

(72) Inventor: Umashankar VELUSAMY, Tampa, FL (US)

(73) Assignee: Verizon Patent and Licensing Inc., Basking Ridge, NJ (US)

(21) Appl. No.: 14/152,021

(22) Filed: Jan. 10, 2014

(51) Int. Cl. G06F 3/0482; H04L 29/08; G06F 3/0484

(52) U.S. Cl. CPC G06F 3/0482; G06F 3/04842; H04L 67/10

(57) ABSTRACT

An approach for implementing a notification platform for engaging and managing user interactions with product or service availability notifications. The approach includes identifying media content presented in proximity to a device. The approach also includes presenting an option for interacting with the media content at the device while the media content is presented. The approach further includes receiving a selection input for initiating the option for interacting with the media content. Additionally, the approach includes transmitting a report of the selection input, a performance of the option, or a combination thereof to the device, a service provider, or a combination thereof.

### BACKGROUND INFORMATION

With technological advances in available user devices and applications, many users utilize a variety of devices to perform various tasks throughout the day. For example, a user device (e.g., a mobile phone, tablet, laptop computer, personal projectors, a television set (TV), a set-top box, etc.) and relevant applications may be utilized to access services for entertainment, online shopping, content consumption, business transactions, or the like. Additionally, some vendors utilize various mechanisms to deliver, at the user devices (e.g., to potential users), advertisements of their current or upcoming services, products, or contents via mass advertising campaigns in various media (e.g., TV, radio, magazines, etc.) However, with the prevalent use of various user devices, it is challenging and costly for the vendors to effectively reach their target consumer/user groups. For example, users may utilize various devices and applications to consume different media content at different times and locations, which could render the mass advertising campaigns less effective. Additionally, some of the target users may skip or miss an advertisement of a product or a service, which they may otherwise be interested in.

Based on the foregoing, there is a need for engaging and managing user interactions with product or service notifications.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system capable of implementing a notification application and platform, according to one embodiment;

FIG. 2 is a diagram of the components of a notification platform, according to one embodiment;

FIG. 3 is a diagram of the components of a user device, according to one embodiment;

FIG. 4 is a flowchart of a process for presenting an option to interact with a media content item, according to one embodiment;

FIG. 5 is a flowchart of a process for initiating an application and updating accounts, according to one embodiment;

FIGS. 6A through 6E are diagrams of user interfaces for use in the processes of FIGS. 4 and 5, according to various embodiments;

FIG. 7 is a diagram of a computer system that can be used to implement various exemplary embodiments; and

FIG. 8 is a diagram of a chip set that can be used to implement an embodiment of the invention.

### DESCRIPTION OF THE PREFERRED EMBODIMENT

An apparatus, method and software for engaging and managing user interactions with product or service notifications are described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

Although the various exemplary embodiments are described for engaging and managing user interactions with notifications different at a user device (e.g., mobile phone, tablet, etc.), wherein the notification may be associated with various products or services and may be presented at different venues (e.g., home, movie theaters, shopping malls, etc.) It is contemplated that these embodiments have applicability to a variety of user devices and processes where a user may be presented with one or more notifications associated with a current or an upcoming service or product that may be offered by one or more vendors, wherein the user may interact with a notification via one or more associated options.

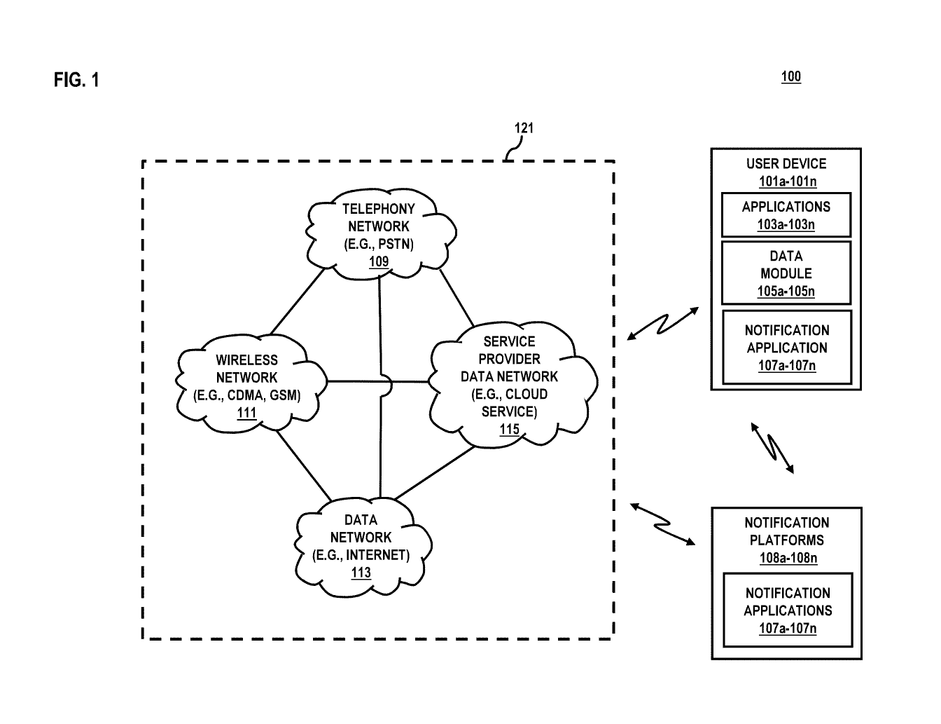

FIG. 1 is a diagram of a system for implementing a product or service availability notification and interaction management application where a user may select from one or more options for interacting with a notification. In some instances, service, product, or content providers (vendors) may find it effective and wish to communicate information (e.g., advertise) about their upcoming products or services so their users may plan accordingly and obtain the services or products once they become available. Also, in some situations, a vendor may benefit from advance sales of its products or services by notifying users and providing options for the users to make advance purchases of the products or services. For example, a user utilizing a certain video game console may be interested to know that a newer game console or newer games will be released in a few weeks, wherein the games/console vendor may present one or more notifications to the user via a user device (e.g., a mobile phone, a current game console, a TV, etc.) while the user is consuming a media content item or is at a certain physical location. In one scenario, a service provider may provide the appropriate services for presenting the information about the products or services available from various vendors and effectuate various components of an advance purchase by a user. However, as previously discussed, with the proliferation of electronic user devices available to the users, the vendors and service providers face additional challenges in effectively communicating information about their products or services to appropriate users at optimum times and venues as well as effectuating an advance purchase or future notifications. Therefore, there is a need for a product or service availability notification and interaction management application.

To address these issues, system 100 of FIG. 1 provides the capability for engaging and managing user interactions with product or service notifications at a user device, according to one embodiment. As previously discussed, in some situations, a vendor may benefit from advance sales of its products or services by notifying users and providing options for the users to make advance purchases of the products or services. In one scenario, the vendors may benefit from the advance purchases by utilizing the proceeds from those sales to produce more products, purchase additional equipment, complete a product, engage in a mass marketing-campaign of the product, or the like. In one example, a vendor may provide one or more incentives (e.g., discounts) for the users who agree to an advance purchase of its product. Further, a service provider may include an additional incentive if the user would agree to additional terms by the service provider (e.g., to conduct the advance purchase via that service provider.) In one use case scenario, a service provider (e.g., a wireless service provider, a media content provider, etc.) may be asked by a vendor (e.g., a movie producer, a video games designer, etc.) to present (e.g., transmit) at a user device (e.g., a tablet, a mobile phone, etc.) a notification/advertising of an availability (e.g., current, future, etc.) of a product/service item (e.g., a new movie, a new video game, a new hair product, etc.) Further, the notification may include one or more options for the user to interact with the notification, and the service provider may perform one or more tasks based on the user interaction. In one scenario, a notification may be presented at a user device based on the user device location, user profile, time/date, service provider configuration, type of product/service, user mood, or the like.

As noted, one example of providing advance information on an upcoming product or service may apply to a motion picture (movie). Traditionally, producing a movie is an expensive process, and marketing of a movie begins with screening of trailers (e.g., a short video clip of one or more scenes in the movie), followed by a heavy advertising campaign before the movie is released for general showing. In many instances, trailers of a movie could affect early opinions of consumers (e.g., movie goers) about the movie if they are able to see the trailers before viewing the entire movie. By way of example, the method of system 100 may be utilized to enable users to easily make an advance purchase of an admission to a showing of a movie while they are viewing a trailer for that movie (e.g., before the main feature presentation.) For example, the movie may be viewed in a theater, via a set-top box on a TV, via a streaming of a content item, or the like. In one instance, the user may be presented with one or more incentives (e.g., a discount of 10%), or free consumer products (e.g., popcorn, an additional free movie pass, a streaming of another movie, etc.) for making the advance purchase. Additionally, the users may have the option of adding the movie to a wish-list if they don't want to make an advance purchase. In one example, a user may scan an image or a code shown on a display screen or by using an application or widget on a user device, which may be synchronized with a device presenting the trailer (e.g., a theater's projection system, a TV set, a set-top box, etc.)

If a user decides to make an advance purchase, for example, it may be effectuated via a service provider where the user purchase and account information may remain confidential. In one example, an electronic admission ticket/pass may be delivered to the user's device and account, where the admission ticket automatically may be activated when the movie is released so that the user can redeem the ticket for a specific date and time in a theater that's convenient for the user. In one scenario, the seller of the ticket would not have any information as to whom the ticket was sold to. Also, certain restrictions may be enforced on the sale of the ticket based on the rating on the movie.

In one scenario, if the user does not want to make an advance purchase, then he may request to add the movie to a wish-list, which may be stored at a user device, at a service provider storage device and associated with the user's profile or account. In one example, once the movie is about to be released or after it is released, the user may automatically be notified and asked if he would like to purchase a discounted ticket, wherein the user may select to effectuate the purchase via one or more service providers.

In one embodiment, one or more options to rate a trailer may be presented during or after the presentation of the trailer. For example, a user may select a rating option to indicate whether the trailer provided enough content for the user to form an opinion about the actual movie. In another example, an option may be for indicating whether the user would be likely to recommend the movie to a friend, a family member, or the like. In one example, an option may be used to compare one trailer to one or more other trailers.

As a potential benefit, producers and/or providers of a movie may realize a stream of income even before the movie is released, which may be due to providing an opportunity for the users to make an impulse advance purchase based on their perception of the trailer.

Similarly, methods of the system 100 may apply to other content items (e.g., audio, books, etc.), consumer products associated with consumption of a content item (e.g., certain food products during a cooking show), and the like.

For the purpose of illustration, the system 100 may include one or more user devices 101a-101n (user device 101), which may include, execute, and utilize one or more applications 103a-103n (also referred to as applications 103), one or more data collection modules 105a-105n (also referred to as Data module 105), and notification applications 107a-107n (also referred to as notification application 107.) Additionally, the system 100 may include one or more notification platforms 108a-108n (also referred to as notification platform 108), which may implemented as a remote and/or a local platform. For example, a remote notification platform may be implemented as a standalone or as an integrated component of a service or a content provider in the network system 121. In one example, a notification platform may be implemented by a local service provider (e.g., a retailer, at a shopping mall, etc.), which may be utilized to provide information on products or services offered by the local service provider. In one embodiment, a local notification platform may be implemented in conjunction with a remote notification platform for combining and presenting information, offers, and incentives available from a remote vendor (e.g., a product producer) and a local vendor (e.g., a retail store.) Further, a notification platform may include or utilize a notification application 107, which may include all or some of the functionalities of a notification application 107 at a user device 101. Depending on capabilities of the user devices 101 of a user, they may have similar, same, or different functionalities and/or may utilize or execute various functionalities of a notification application 107. In various embodiments, a notification application 107 may be an independent application or widget which may be included in a user device by a manufacturer of the user device, or it may be downloaded by a user of the user device. Additionally, the notification application 107 may be independent of an operating system of a user device or it may be implemented based on the operating system at a user device.

Furthermore, the system 100 may include a network system 121, which may include one or more networks, including a telephony network 109, a wireless network 111, a data network 113, a service provider data network 115, etc. By way of example, the networks 109, 111, 113, and 115 may be any suitable wireline and/or wireless network, which may be managed by one or more service providers. In one example, the networks 109, 111, 113, and 115 may be one or more elements in a network system 121, which may include various components and elements for providing a range of communication and network services. For example, telephony network 109 may include a circuit-switched network, such as the public switched telephone network (PSTN), an integrated services digital network (ISDN), a private branch exchange (PBX), or other like network. Wireless network 111 may employ various technologies including, for example, code division multiple access (CDMA), enhanced data rates for global evolution (EDGE), general packet radio service (GPRS), mobile ad hoc network (MANET), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (WiFi), satellite, and the like. Meanwhile, data network 113 may be any local area network (LAN), metropolitan area network (MAN), wide area network (WAN), the Internet, or any other suitable packet-switched network, such as a commercially owned, proprietary packet-switched network, such as a proprietary cable or fiber-optic network.

Although depicted as separate entities, networks 109, 111, 113, and 115 may be completely or partially contained within one another, or may embody one or more of the aforementioned infrastructures. For instance, the service provider network 115 may embody circuit-switched and/or packet-switched networks that include facilities to provide for transport of circuit-switched and/or packet-based communications. It is further contemplated that networks 109, 111, 113, and 115 may include components and facilities to provide for signaling and/or bearer communications between the various components or facilities of system 100. In this manner, networks 109, 111, 113, and 115 may embody or include portions of a signaling system 7 (SS7) network, or other suitable infrastructure to support control and signaling functions.

By way of examples, the user devices 101 may communicate with other devices via one or more proximity-based communication channels or via one or more network service providers in the network system 121. Further, the applications 103 may include various applications for productivity, education, entertainment, social networking, web browser, communications, content sharing, multimedia applications, user interface (UI), map application, web client, or the like.

In one embodiment, a user device 101 may utilize a Data module 105 for determining/collecting data or content associated with the user device 101, one or more users of the user device 101, the applications 103, one or more content items (e.g., multimedia content), and the like. In addition, the user device 101 can execute an application 103 that is a software client for storing, processing, and/or forwarding one or more information items to other components of the system 100. In various embodiments, the Data module 105 may include various sensors for detecting and capturing various signals, information, and contents, for example, audio, video, location information, Bluetooth signals, near field communication (NFC) signals, wireless local area network (WLAN) signals, RFID signals, or the like. Further, the collected information, content, or signals may be shared, via the applications 103 and/or the notification application 107, with other user devices 101, or service providers in the network system 121.

It is noted that user devices 101 may be any type of mobile terminal, fixed terminal, or portable terminal including a mobile handset, station, unit, device, multimedia computer, multimedia tablet, Internet node, communicator, desktop computer, laptop computer, Personal Digital Assistants (PDAs), smartphone, set-top box, TV set, or any combination thereof. It is also contemplated that the user devices 101 can support any type of interface for supporting the presentment or exchanging of data. In addition, user devices 101 may facilitate various input means for receiving and generating information, including touch screen capability, keyboard and keypad data entry, voice-based input mechanisms and the like. Any known and future implementations of user devices 101 are applicable. In certain embodiments, user devices 101 may be configured to establish peer-to-peer communication sessions with each other using a variety of technologies, including near field communication (NFC), Bluetooth, ZigBee, infrared, etc. Also, connectivity can be provided via a wireless local area network (LAN). By way of example, a group of user devices 101 may be configured to a common LAN so that each device can be uniquely identified via any suitable network addressing scheme.

In various embodiments, the user devices 101 may communicate with one or more components of the system 100 (e.g., a notification platform, another user device, etc.) via one or more proximity-based communication methods and protocols. For example, the communication may be via Bluetooth®, a wireless local area network (WLAN), or other available communication methods. In various examples, the notification application 107 may communicate with one or more networks and service providers of the network system 121 to provide information and/or request information or services from the service providers. In various scenarios, a notification application 107 on a user device 101 may request or utilize information from the applications 103 or the Data module 105 to determine status information associated with one or more processes, applications, content items, UI presentation options, available options, available functionalities, user profile, user preferences, user configuration, device configuration, or the like.

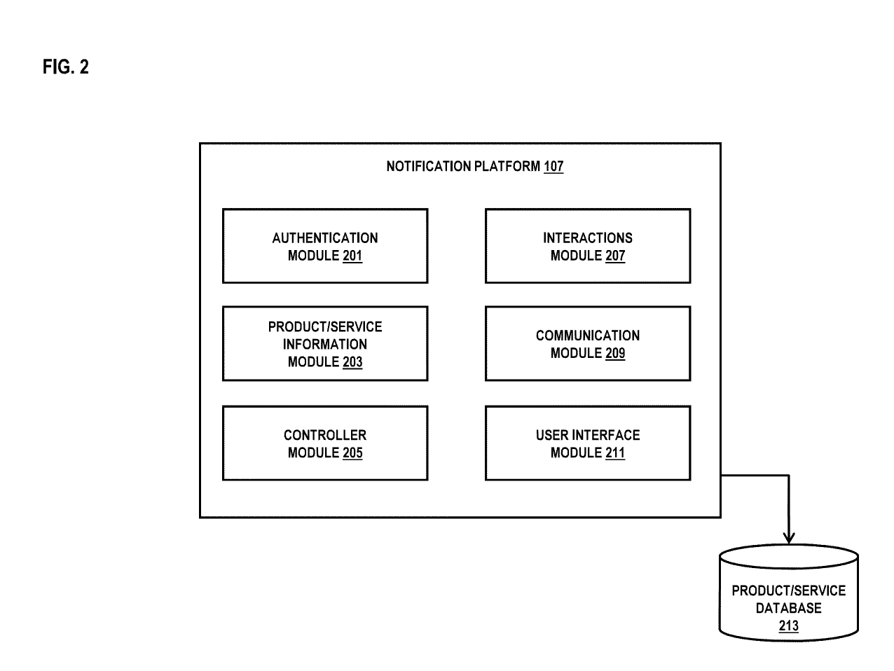

FIG. 2 is a diagram of the components of a notification platform, according to one embodiment. The notification platform 108 includes various executable modules for performing one or more computing, data processing and network based instructions that in combination provide a means of engaging and managing user interactions with product or service notifications at a user device. Such modules can be implemented in hardware, firmware, software, or a combination thereof. By way of example, the notification platform 108 may include an authentication module 201, product/service information module 203, controller module 205, interactions module 207, communication module 209, and a user interface module 211. In addition, the notification platform 108 also maintains data, in a product/service database 213, as received from various product or service vendors.

In one embodiment, an authentication module 201 authenticates users and user devices 101a-101n for interaction with the notification platform 108. By way of example, the authentication module 201 receives a request from a user of a device 101 to subscribe to the notification platform 108 service for enabling receipt of advance information and offers on upcoming products or services. The subscription process may include enabling discovery of and communication between the user device 101 and a notification platform 108. Other settings may include specifying a method for communicating the information or offers to the user device 101, such as e-mail, short messaging service (SMS), or as a web-based communication. Additionally, various capabilities of the user device 101 may be determined, for example, in relation to media content presentation, user interface, processing power, or the like. In certain instances, the initial authentication process may also involve the uploading of the notification application 107 onto the user device 101.

The authentication process performed by the authentication module 201 may also include receiving and validating a login name and/or user identification value as provided or established for a particular user during a subscription or registration process with the service provider. The login name and/or user identification value may be received as input provided by the user from the user device 101. Alternatively, the login process may be performed through automated association of profile settings maintained by the notification platform 108, or one or more other service/content providers. For example, user device information may include an identification signal generated by an active user device, i.e., a carrier detection signal, IP address, mobile directory number (MDN), subscriber identity module (SIM) (e.g., of a SIM card), radio frequency identifier (RFID) tag, or customer identifier value determined from one or more other user accounts at one or more service providers. By way of example, the authentication module 201 may utilize one or more validated user information items to initiate one or more interactions with one or more other service providers associated with one or more user accounts at, for example, a bank, a communication service provider, a physical-location or on-line retailer, or the like.

In one embodiment, a product/service information module 203 may operate in connection with the user interface module 211 and the controller module 205 to enable presentation of products or services information, offers, options, or the like that may be included in presentation of a media content. By way of example, the product/service information module 203 may present specific reference to product or service codes and identifiers, manufacturer codes, discount levels, etc. In addition, the information may specify terms, conditions, purchase pricing and other information useful for a user to make a decision on making an advance purchase or at least to add the product or service information to a wish-list. In one embodiment, the product/service information module 203 may receive or retrieve the product or service information from a vendor and then include a presentation of that information into a presentation of media content. In one embodiment, the product/service information module 203 may cause a message to be generated at a user device, for example, to present details of an advance purchase transaction (e.g., account information.)

In one embodiment, a controller module 205 is configured to operate and effectuate the processes by or at the other modules of the notification platform 108. For example, the controller module 205 may generate the appropriate signals to control the communication module 209 and the product/service information module 203 for facilitating transmission of the information over the network system 121. By way of example, the communication module 209 executes various protocols and data sharing techniques for enabling collaborative execution between a user device 101 and the notification platform 108.

In one embodiment, the interactions module 207 may operate in conjunction with the product/service information module 203 and the controller module 205 to determine and present one or more options for a user to interact with a notification associated with a product or a service offer presented in a media content item presentation. In various examples, the options may include a response indicative of an interest in the offering, adding the notification information to a wish-list, and one or more selection inputs by the user. For example, in response to an indication of interest by the user in the product or service the interactions module 207 may cause a presentation of a graphical UI for listing further details and information regarding the product or service of interest. As another example, in response to a request to purchase the product or service of interest, the user may be presented with one or more prompts for initiating and/or concluding a purchase option. In one embodiment, the interactions module 207 may also interact with the authentication module 201 and controller module 205 to for the settings and preferences of a user account or a user profile. For example, the user may be given the option to adapt how they receive advance product or service information, including product/service categories of interest to them, a maximum price limit, etc.

In one embodiment, the communication module 209 may be utilized to communicate with various applications, modules, or components at a user device 101 for presenting information, options, notification, or the like associated with a product or service. Additionally, the communication module 209 may be utilized to communicate with one or more components of the system 100. In one scenario, the communication may be effectuated via a communication module available at the user device 101. In one embodiment, the communication module 209 may utilize one or more communication channels to communicate one or more update messages, command message, inquiry message, or the like.

In one embodiment, the UI module 211 may cause a rendering or presentation of a dynamic UI including various information and options associated with processes, applications, content items, or the like. In one example, the presentation may include visual effects on the presented options. In various scenarios, the presentation may include one or more augmented or virtual reality elements, which may provide additional visual effects for a better, more effective, or user friendly experience. In one embodiment, the UI module 211 may cause a presentation of a UI at a user device so that a user may interact with one or more elements present in a media item, one or more current update information, or the like. In one embodiment, the UI module 211 may provide various options for a user to select, highlight, or float over one or more content items at a user device 101. In one embodiment, the UI elements may be determined based on a media content item, options, information items, or the like that may be presented at the user device 101. By way of example, the user interface module 211 may generates a UI in response to application programming interfaces (APIs) or other function calls corresponding to service provider, the notification platform 108, or the like for enabling display of graphical and textual elements. Additionally, the UI elements may be generated at the user device 101 to enable viewing of a media content item and various notification and information items included therein.

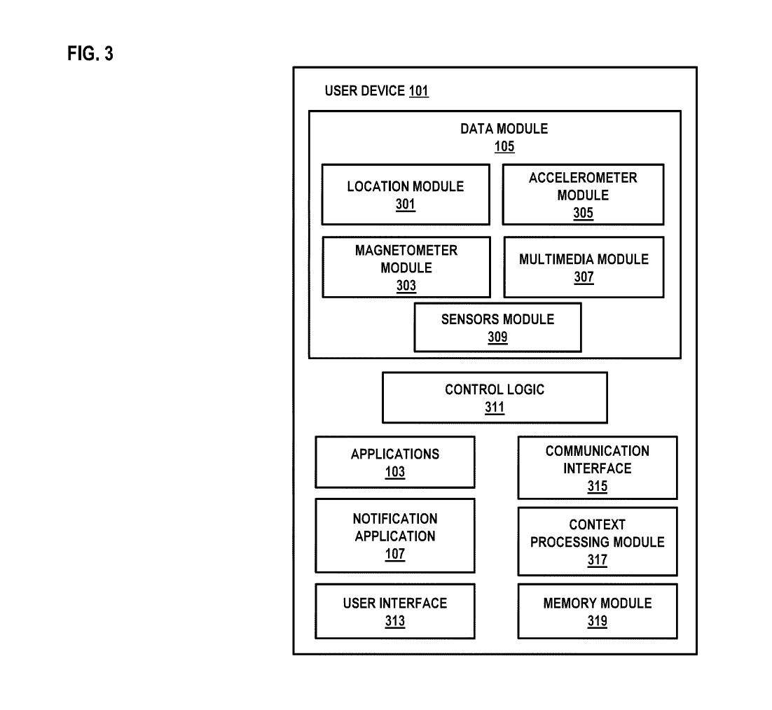

FIG. 3 is a diagram of the components of a user device, according to one embodiment. By way of example, a user device 101 includes one or more components for executing various applications, enabling various functionalities, and for communicating with other user devices 101 or with other components of the system 100. It is contemplated that the functions of these components may be combined in one or more components or performed by other components of equivalent functionality. In one embodiment, the user device 101 includes a Data module 105, which may include one or more location modules 301, magnetometer modules 303, accelerometer modules 305, multimedia module 307, and sensors module 309. Further, the user device 101 may also include control logic 311 to coordinate the use of other components of the user device 101, a user interface 313, a communication interface 315, a context processing module 317, and a memory module 319. The applications 103 and the notification application 107 may execute on the control logic 311 utilizing the components of the user device 101.

The location module 301 can determine a user's location, for example, via location of a user device 101. The user's location can be determined by a triangulation system such as GPS, assisted GPS (A-GPS), Cell of Origin, or other location extrapolation technologies. Standard GPS and A-GPS systems can use satellites to pinpoint the location of a user device 101. A Cell of Origin system can be used to determine the cellular tower that a cellular user device 101 is synchronized with. This information provides a coarse location of the user device 101 because the cellular tower can have a unique cellular identifier (cell-ID) that can be geographically mapped. The location module 301 may also utilize multiple technologies to detect the location of the user device 101. Location coordinates (e.g., GPS coordinates) can give finer detail as to the location of the user device 101 when media is captured. In one embodiment, GPS coordinates are stored as context information in the memory module 319 and are available to the context processing module 317, the Data module 105, and/or to other entities of the system 100 (e.g., via the communication interface 315.) Moreover, in certain embodiments, the GPS coordinates can include an altitude to provide a height. In other embodiments, the altitude can be determined using another type of altimeter.

The magnetometer module 303 can be used in finding horizontal orientation of the user device 101. A magnetometer is an instrument that can measure the strength and/or direction of a magnetic field. Using the same approach as a compass, the magnetometer is capable of determining the direction of a user device 101 using the magnetic field of the Earth. The front of a media capture device (e.g., a camera) can be marked as a reference point in determining direction. Thus, if the magnetic field points north compared to the reference point, then the angle of the user device 101 from the magnetic field is known. Simple calculations can be made to determine the direction of the user device 101. In one embodiment, horizontal directional data obtained from a magnetometer can be stored in memory module 319, made available to other modules and/or applications 103 of the user device 101, and/or transmitted via the communication interface 315 to one or more entities of the system 100.

The accelerometer module 305 can be used to determine vertical orientation of the user device 101. An accelerometer is an instrument that can measure acceleration. Using a three-axis accelerometer, with axes X, Y, and Z, provides the acceleration in three directions with known angles. Once again, the front of a media capture device can be marked as a reference point in determining direction. Because the acceleration due to gravity is known, when a user device 101 is stationary, the accelerometer module 305 can determine the angle the user device 101 is pointed as compared to Earth's gravity. In certain embodiments, the magnetometer module 303 and accelerometer module 305 can be means for ascertaining a perspective of a user. This perspective information may be stored in the memory module 319, made available to other modules and/or applications 103 of the user device 101, and/or sent to one or more entities of the system 100.

In one embodiment, the multimedia module 307 may be utilized to generate, receive, or consume, etc. various content/media items, for example, images, video, audio, text, and the like. In various embodiments, the media items may be shared with the applications 103 or the notification application 107, which in turn may share the media with one or more components of the system 100. In various embodiments, the multimedia module 307 may interface with various sensors; for example, a camera, a microphone, etc., to determine additional contextual information associated with a media item, a code associated with a notification or a content item, and the like.

In various embodiments, the sensors module 309 can process sensor data from various sensors (e.g., microphone, optical, Bluetooth, NFC, GPS, accelerometer, gyroscope, thermometer, etc.) to determine environmental (e.g., atmospheric) conditions surrounding the user device 101, user mood, location information, and various other information from a range sensors that may be available on one or more devices. For example, the sensors module 309 may detect conditions including humidity, temperature, geo-location, biometric data of the user, etc. Once again, this information can be stored in the memory module 319 and sent to the context processing module 317 and/or to other entities of the system 100. In certain embodiments, information collected from the Data module 105 can be retrieved by the control logic 311 and stored at the memory module 319, made available to other modules and/or applications 103 of the user device 101, and/or sent to one or more entities of the system 100.

The user interface 313 can include various methods for a user to interface with applications, modules, sensors, and the like at a user device 101. For example, the user interface 313 can have outputs including a visual component (e.g., a screen), an audio component, a physical component (e.g., vibrations), and other methods of communication. User inputs can include a touch-screen interface, a scroll-and-click interface, a button interface, a microphone, etc. An input may be via one or more methods such as voice input, textual input, typed input, typed touch-screen input, other touch-enabled input, etc. In one embodiment, the user interface 313 may interact with the user interface module 211 of the notification application 107 for determining and presenting a dynamic UI and applicable options based on a notification or user interactions with a notification.

In one embodiment, the communication interface 315 can be used to communicate with one or more entities of the system 100, for example, to submit a request for and receive a content stream from various content stream providers. In various embodiments, the communication interface 315 may facilitate communications via one or more wireless communication channels and protocols, for example, WLAN, RFID, NFC, Bluetooth Smart, Bluetooth, Ant+, Z-Wave, ZigBee, or the like, wherein the communication channels may be established via one or more sensors, transceivers, transmitters, receivers, wireless charging interface, or the like. Certain communications can be via methods such as an internet protocol, messaging (e.g., SMS, multimedia messaging service (MMS), etc.), or any other communication method (e.g., via the network system 121). In some examples, the user device 101 can send context information associated with the user device 101 to other user devices 101 and/or to other entities of the system 100. In one embodiment, the communication interface 315 may interact with the communication module of the notification application 107 in order to effectuate a communication of one or more notifications, interaction indicators, interaction options, command messages, or the like.

The context processing module 317 may be executing on the control logic 311 for determining context information from the Data module 105, the applications 103, or the notification application 107. This information may be transmitted, via the communication interface 315, to one or more user devices 101 and/or to other entities of the system 100. The context processing module 317 may additionally be utilized as a means for determining information related to the user, an instance of data, a value, a process, a content item, an object, a subject, that an application 103 is being executed, and the like. In certain embodiments, the context processing module 317 can infer higher level context information from the context data such as activity at a user device 101, user information, etc. In one example, contextual information associated with one or more media items, consumption of a media item, one or more notifications, one or more interactions with a notification, or the like may be determined and shared with one or more local or network-based service providers.

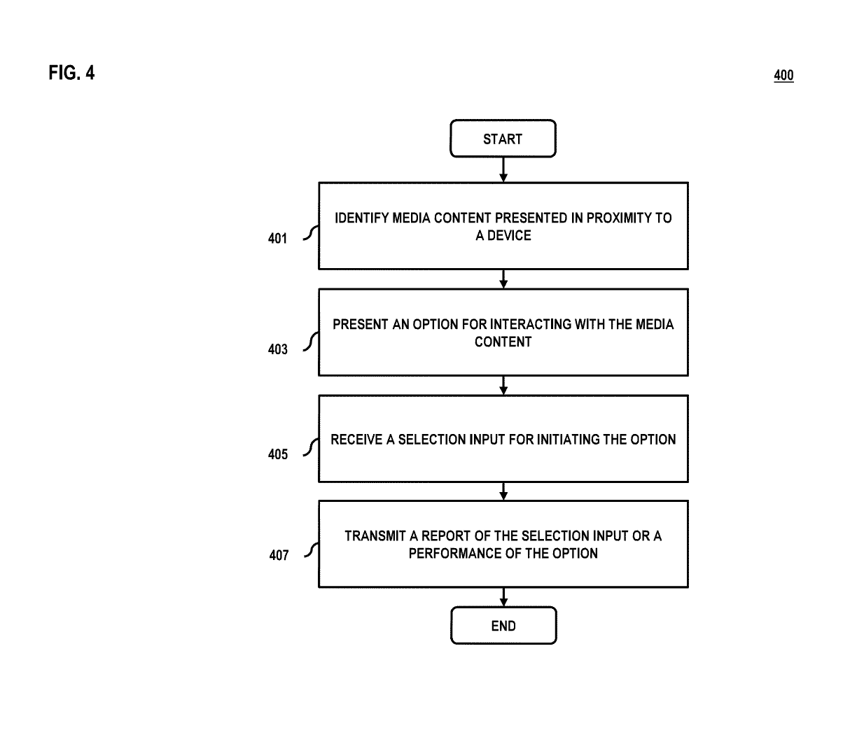

FIG. 4 is a flowchart of a process for presenting an option to interact with a media content item, according to one embodiment. For the purpose of illustration, process 400 is described with respect to FIG. 1. It is noted that the steps of the process 400 may be performed in any suitable order and by any of the components of the system 100, as well as combined or separated in any suitable manner.

As shown in FIG. 4, in step 401, a notification platform 108 may identify media content presented in proximity to a device. In one embodiment, the notification platform may be remote or local with reference to the location of the device, and it may determine that one or more user devices 101 are in proximity where a media content item is presented. For example, the media content may be presented in a theater, on a TV set, on a user device 101, on a display monitor in a store, at a computer display, or the like. In one embodiment, a notification platform may determine the presence of a user device 101 by detecting one or more signals from the user device 101, which may be generated by one or more sensors at the user device 101. In one example, the notification platform may detect and process one or more signals from one or more communication sensors at a user device 101 and determine that the user device 101 is in close proximity to where the media content is being presented. In one embodiment, the media content is a trailer for a product, a service, or a combination thereof. In one scenario, the media content may include advance information about the product or service before they are available to users. For example, a trailer may provide information about an upcoming movie, a new game console, a new videogame, or the like. In one scenario, the media content may be included in and be presented as part of a presentation of another media content item. For example, the media content may be presented as a trailer (e.g., an ad) before, during, or after the presentation of the main media content. In one embodiment, a presentation of the media content may be transferred to or simultaneously presented at the user device 101. For example, a notification platform 108 may cause the presentation of a movie trailer to be transferred onto a user device 101 or simultaneously be presented on the user device 101 and on an external presentation display. In one example, the notification platform 108 may itself stream or request a source of the media content (e.g., a local server near the user device 101) to stream the media content to the user device 101. In one embodiment, a user of a user device 101 may request the transfer or the simultaneous presentation of the media content item.

In step 403, a notification platform 108 may present an option for interacting with the media content at the device while the media content is presented. In various embodiments, the option for interacting with the media content includes (a) a purchase of the product, the service, or a combination thereof; (b) an addition of the product, the service, or a combination thereof to a wish-list; or (c) a combination thereof. In one use case scenario, a media content presentation may include information/notification about an upcoming product or service, for example, about a new movie or a new videogame that will be available in a few months/weeks/days. Further, a notification platform 108 may present one or more options for a user to interact with the media content, which may further present one or more other options for a user to interact with a product or service offer included in the media content. For example, a user may select (e.g., via a UI feature on the user device 101) a video clip presenting advance information on an upcoming movie and when the user selects/interacts with the video clip, additional information and offers may be presented to the user. In various scenarios, the user may select to make an advance purchase of the product or service presented in the media content, and/or the user may choose to add the product or service to a wish-list, which may be at the user device 101 and/or at one or more remote storage devices (e.g., a service provider network server.) In one embodiment, the wish-list may be shared with one or more other users, for example, via one or more social network sites, one or more communication messages (e.g., SMS, email, etc.), or the like. In one embodiment, a presentation of information or options on a product or a service may include one or more incentives offered by one or more vendors associated with the product, the service, or the offer. For example, a movie producer (e.g., a studio, a person, etc.) may offer a 10% discount if a user chooses to buy an advance admission ticket to an upcoming movie that was presented in the trailer.

In step 405, a notification platform 108 may receive a selection input for initiating the option for interacting with the media content. In one embodiment, the selection input is made by scanning a code associated with the media content. In one scenario, a user may be viewing a movie trailer, an advertisement on TV for a new restaurant in town, a short video clip displayed in a shopping mall about a new service in the mall, or the like, wherein a graphical code (e.g., a quick response (QR) barcode) may be associated and presented in the media content or on a nearby display (e.g., a poster board.) Further, the user may utilize a user device 101 to scan or capture an image of the code and transmit that code or image to a notification platform 108, wherein the processing of the code or image by the notification platform 108 and/or a service provider may indicate to one or more user selection inputs. For example, a user may scan and transmit a code associated with a movie trailer to a service provider (e.g., a wireless communication service provider, a content provider, an online shopping vendor, etc.), wherein the code may indicate that the user selects the purchase an advance admission ticket to a future showing of an upcoming movie. In another example, a code submitted by a user may indicate that the user would like to add information of the upcoming movie to a wish-list.

In one embodiment, the notification platform 108 may cause the notification application 107 at a UE 101 to store data (e.g., bookmark) related to a media content item presented to the user. For example, when a user accesses the application at a later time, the same media content item and notifications may be reproduced and presented in the same sequence, wherein the user may be presented with one or more options for interacting with the media content item and the notifications therein. In one embodiment, the data and the future presentation of a media content item and included notifications may be valid for a period of time defined by the user, a service provider, the applications 103, the notification application 107, the notification platform 108, or the like. In one embodiment, a user may be directed to a network site, e.g., a QR code may cause a launching of an application (e.g., 103, 107, etc.) for accessing a website and interacting with a content item and one or more notifications therein, which previously may have been presented at a UE 101 and/or via one or more presentation displays (e.g., at a movie theater.)

In step 407, a notification platform 108 may transmit a report of the selection input, a performance of the option, or a combination thereof to the device, a service provider, or a combination thereof. In one example, the report may indicate that the user selected to make an advance purchase of a product or a service presented in the media content and a report indicating that selection may be sent to the user device, a service provider and/or a vendor associated with the product or service. In one embodiment, the report may indicate whether a service provider and/or a vendor associated with the product or service has performed an option selected by the user. For example, the report may indicate that a service provider completed the performance of a purchase option received from the user.

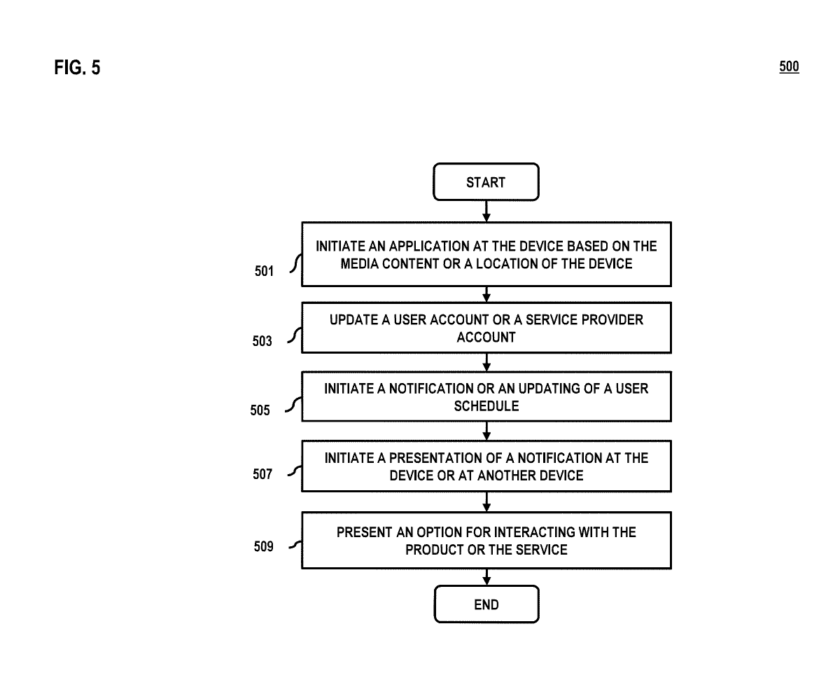

FIG. 5 is a flowchart of a process for initiating an application and updating accounts, according to one embodiment. For the purpose of illustration, process 500 is described with respect to FIG. 1. It is noted that the steps of the process 500 may be performed in any suitable order and by any of the components of the system 100, as well as combined or separated in any suitable manner.

As shown in FIG. 5, in step 501, a notification platform 108 may initiate an application at the device based on the media content, a location of the device, or a combination thereof. In one embodiment, one or more applications 103, the notification application 107, or the like may be caused to be executed at a user device 101 based on a media content type that is presented in close proximity to the user device 101. In one embodiment, execution of an application at the user device 101 may be based on a mode (e.g., on what kind of device/displayed) that the media content is presented in. For example, the media content may be presented on a TV set, on a computer monitor, projected on a big-screen, or the like. In one embodiment, the execution of an application at the user device 101 may be based on physical location of the user device 101. For example, the notification platform 108 and/or a service provider may determine location information of the user device 101 based on location information (e.g., GPS coordinates, cellular tower information, etc.) determined from information associated with the user device 101.

In step 503, a notification platform 108 may update a user account, a service provider account, or a combination thereof associated with the device based on the selection input. In various scenarios, an update may include a credit note, a debit note, a charge note, or the like. In one embodiment, a notification platform 108 may update a user account at one or more service providers. For example, an update for an advance purchase of a product by a user may be a debit note to a user's bank account, a charge note to a user account with a communication service provider (e.g., a cellular service provider, an Internet service provider, etc.), or the like. In one embodiment, the update may include a credit note to a service provider account, content provider account, a vendor account, or the like, which may be associated with offering the product or service that a user is making an advance purchase of. For example, a notification platform 108 operated by a first service provider may effectuate a user selection for an advance purchase of an admission to a future presentation of an upcoming movie. Further, the first service provider may submit a debit note, equivalent to an amount agreed by the user, to the user's bank account and then submit one or more credit notes (e.g., according to set agreements) to one or more accounts of the service provider, content provider, vendor, or the like, that are associated with the presentation of the upcoming movie.

In step 505, a notification platform 108 may initiate a notification, an updating of a user schedule, or a combination thereof based on the selection input. In one scenario, a notification (e.g., SMS, email, etc.) may be to indicate to a user of a recent advance purchase of a product or service. In one embodiment, the notification platform 108 may update one or more user schedules and include information about an advance purchase of a product or service and/or the addition to a wish-list of information about an upcoming product or service.

In step 507, a notification platform 108 may initiate a presentation of a notification at the device, at another device or a combination thereof associated with a user based on the wish-list. In one scenario, a user selection input may have been for a notification platform 108 to add to a wish-list information about an upcoming product or a service, wherein the notification platform may initiate a presentation of a notification (e.g., SMS, email, etc.) at the user device indicating that the product or service is now or may soon be available. In one embodiment, the notification platform 108 may cause the presentation of the notification at one or more other user devices (e.g., mobile phone, a personal computer, a tablet, etc.)

In step 509, a notification platform 108 may present an option for interacting with the product, the service, or a combination thereof on the wish-list. In one scenario, a user may be presented with an option to effectuate a purchase of the product or service on the wish-list. In one example, the user may be presented with an option to forward/share the information on the wish list with one or more other users. For example, the information or notification about a product or a service on the wish-list of a first user may be presented to another user (e.g., a friend, a family member, or the like of the first user) at his user device so that the other user may choose to purchase that product or service for himself and/or for the first user.

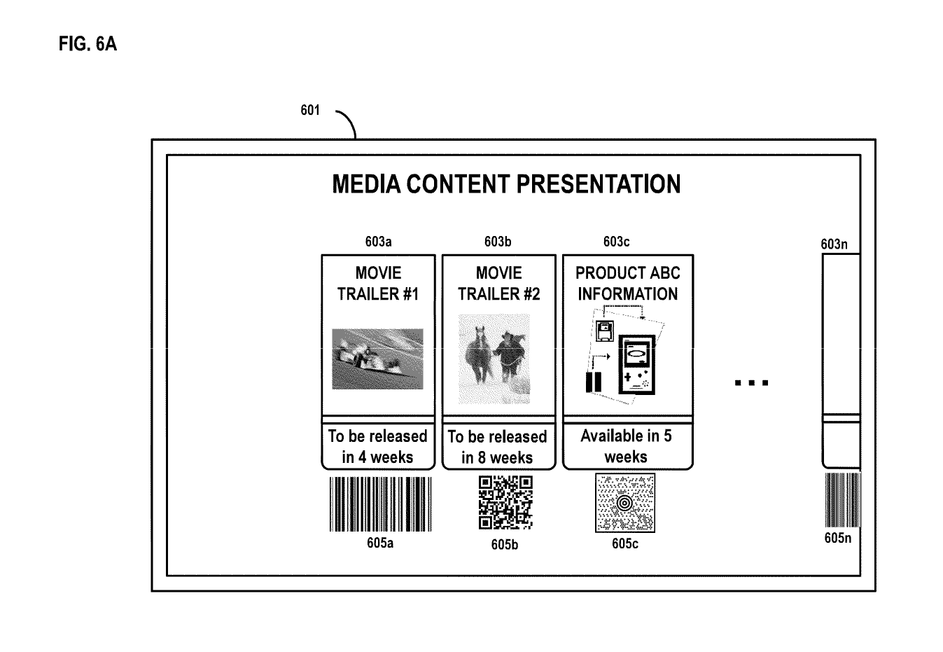

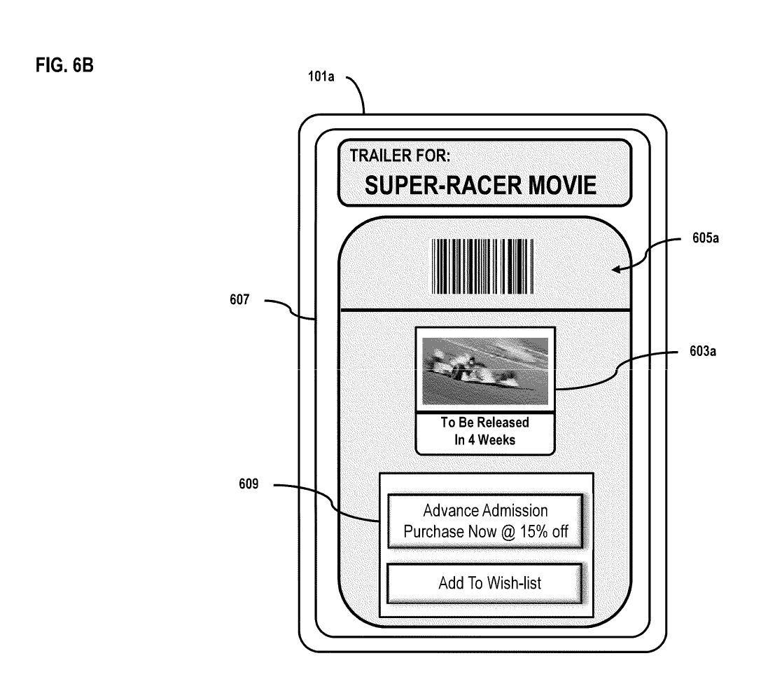

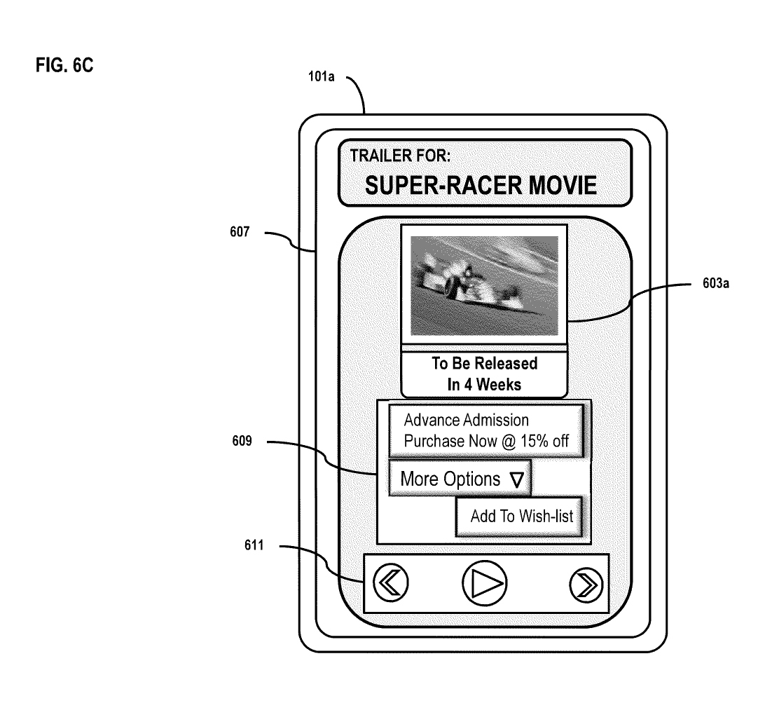

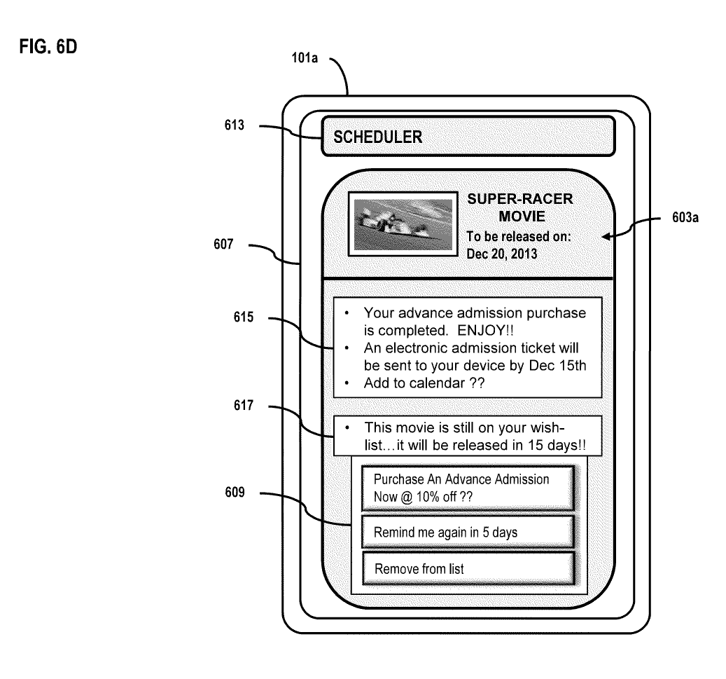

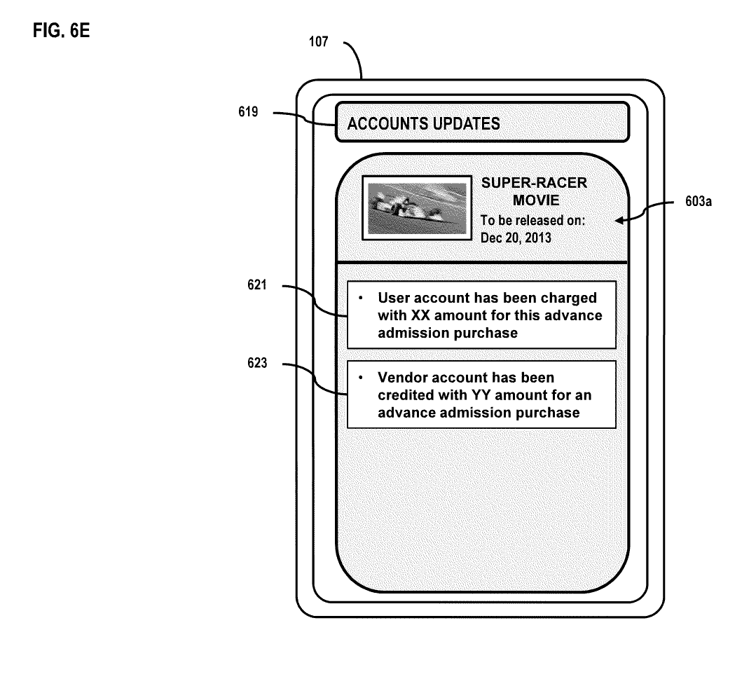

FIGS. 6A through 6E are diagrams of user interfaces for use in the processes of FIGS. 4 and 5, according to various embodiments.

FIG. 6A includes an illustration of a media content presentation 601, which may be via one or more user devices 101 or via one or more other media content presentation devices and methods. For example, a user may view a media content item via a set-top box and a TV set wherein the user may interact with the media content item. In another example, the user may be viewing a media content item on a shared display, e.g., in a movie theater, at a mall, in a store, etc. In one scenario, before, during, or after the presentation of the media content item, a service/content provider may present notifications/information related to upcoming products or services, which may be available via one or more vendors at one or more geo-locations. For example, the media content presentation 601 may also present movie trailers 603a (movie trailer #1), 603b (movie trailer #2), notification 603c as product “ABC” information, and one or more notifications 603n on other products or services. Additionally, each notification 603a-603n may also be associated with a unique code (e.g., barcode) 605a-605n. In one embodiment, a user may utilize a user device 101 to scan a barcode associated with a certain notification for receiving or determining additional information about the product or service presented in that notification. For example, an application 103 or a notification application 107 at a user device 101 may be utilized to scan the barcode 605a, which may be transmitted to a service provider for receiving additional information about the notification 603a, or the barcode may be processed at the user device for determining possible information encoded into the barcode 605a.

FIG. 6B includes an illustration of a user interface 607 at a user device 101a, which is used to scan the barcode 605a. In one embodiment, the barcode 605a may be transmitted to a notification platform 108, which may return one or more information items associated with the product 603a (e.g., movie trailer #1). In one example, the information items may include additional product information in the form of a textual, audio, or video message. In one embodiment the notification platform 108 may cause a presentation of one or more options 609 so that the user may interact with the notification associated with the product or service that the user is interested in. In one scenario, the user may choose from the options 609 to initiate an advance admission purchase now with a 15% discount. Additionally, the user may choose the option to add the notification information to a wish-list, which may be at a local user device or at a service provider storage device. In one example, notifications on a user's wish-list may be shared with one or more other users.

FIG. 6C includes the illustration of the user interface 607, which is utilized to view the media content presentation 601 of FIG. 1. In various examples, the notification platform 108 may cause the media content presentation 601 to be presented at the user device 101 or the user of the user device 101a may request it. In one scenario, the user may utilize one or more options to interact with the notifications 603a-603n presented on the user device 101a. For example, the user may select from the options 609 to initiate an advance admission purchase or, with more options, to add the notification 603a to a wish-list. Additionally, the user may utilize UI options 611 to interact with a media content item, for example, play the media content item, skip to the next or previous notification based on the availability of notifications in the media content presentation.

FIG. 6D includes an illustration of the user interface 607, which includes scheduling functions. In one embodiment, a scheduler 613 may be part of a notification application 107 or an application 103, which may be used to provide scheduling information and functions at the user device 101a. In one scenario, the UI 607 may present the notification 603a that is related to the movie trailer #1. In one use case, information items and functionality in 615 may be presented to the user, wherein the information may indicate that the user's advance admission purchase for the movie associated with the notification 603a has been completed and additionally, an electronic admission ticket would be sent to the user device by a certain date. Further, the scheduler may inquire if the user would like to add a reminder to a calendar indicative of the release date of the movie. In another use case, the prompt 617 may indicate to the user that the movie associated with the notification 603a is still on the user's wish-list and inquire if the user would like purchase an advance admission now at a certain discount offer. In one example, the offer discount may be more or less than the original discount. In various examples, the user may select from the options 609 to initiate a purchase, request another reminder, remove a notification from the wish-list, or other options as available.

FIG. 6E includes an illustration of account updates associated with a user account and one or more vendor accounts. In one scenario, the notification platform 108 may initiate accounts updates 619 and provide an update 621 indicating that a user account has been charged “XX” amount for an advance admission purchase associated with the notification 603a. Additionally, the notification platform 108 may provide an update 623 indicating that one or more vendors' accounts have been credited with “YY” amount for the advance admission purchase associated with the notification 603a. In various use case scenarios, the amounts “XX” and “YY” may be different or the same, which may be according to various agreements between a service provider that is handling the transactions for the vendors. For example, a service provider may charge a fee to a user and a vendor associated with a certain purchase transaction.

To the extent the aforementioned embodiments collect, store or employ personal information provided by individuals, it should be understood that such information shall be used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

The exemplary techniques and systems presented herein enables engaging and managing user interactions with product or service notifications at a user device. As an advantage, a notification platform may be utilized to present to a user notifications and information associated with various upcoming products or services. Additionally, various options may be presented to the user so that the user may interact with the notifications and the notification platform 108 in relation to the products and services.

The processes described herein for facilitating a notification platform and/or a notification application may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

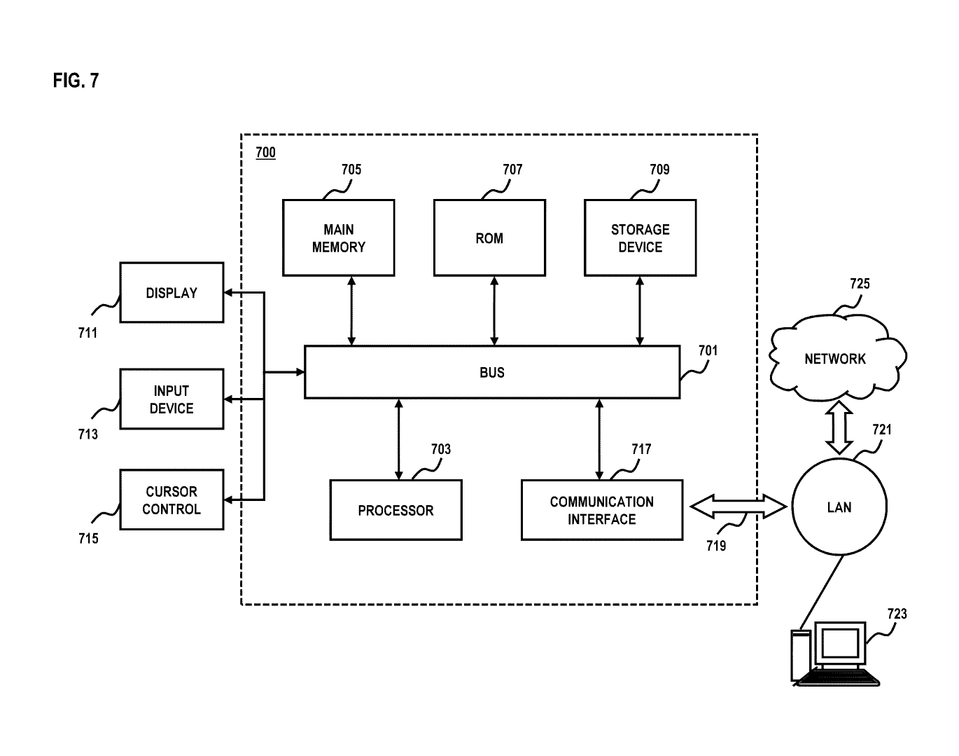

FIG. 7 illustrates computing hardware (e.g., computer system) upon which an embodiment according to the invention can be implemented. The computer system 700 includes a bus 701 or other communication mechanism for communicating information and a processor 703 coupled to the bus 701 for processing information. The computer system 700 also includes main memory 705, such as random access memory (RAM) or other dynamic storage device, coupled to the bus 701 for storing information and instructions to be executed by the processor 703. Main memory 705 also can be used for storing temporary variables or other intermediate information during execution of instructions by the processor 703. The computer system 700 may further include a read only memory (ROM) 707 or other static storage device coupled to the bus 701 for storing static information and instructions for the processor 703. A storage device 709, such as a magnetic disk or optical disk, is coupled to the bus 701 for persistently storing information and instructions.

The computer system 700 may be coupled via the bus 701 to a display 711, such as a cathode ray tube (CRT), liquid crystal display, active matrix display, or plasma display, for displaying information to a computer user. An input device 713, such as a keyboard including alphanumeric and other keys, is coupled to the bus 701 for communicating information and command selections to the processor 703. Another type of user input device is a cursor control 715, such as a mouse, a trackball, or cursor direction keys, for communicating direction information and command selections to the processor 703 and for controlling cursor movement on the display 711.

According to an embodiment of the invention, the processes described herein are performed by the computer system 700, in response to the processor 703 executing an arrangement of instructions contained in main memory 705. Such instructions can be read into main memory 705 from another computer-readable medium, such as the storage device 709. Execution of the arrangement of instructions contained in main memory 705 causes the processor 703 to perform the process steps described herein. One or more processors in a multi-processing arrangement may also be employed to execute the instructions contained in main memory 705. In alternative embodiments, hard-wired circuitry may be used in place of or in combination with software instructions to implement the embodiment of the invention. Thus, embodiments of the invention are not limited to any specific combination of hardware circuitry and software.

The computer system 700 also includes a communication interface 717 coupled to bus 701. The communication interface 717 provides a two-way data communication coupling to a network link 719 connected to a local network 721. For example, the communication interface 717 may be a digital subscriber line (DSL) card or modem, an integrated services digital network (ISDN) card, a cable modem, a telephone modem, or any other communication interface to provide a data communication connection to a corresponding type of communication line. As another example, communication interface 717 may be a local area network (LAN) card (e.g. for Ethernet™ or an Asynchronous Transfer Mode (ATM) network) to provide a data communication connection to a compatible LAN. Wireless links can also be implemented. In any such implementation, communication interface 717 sends and receives electrical, electromagnetic, or optical signals that carry digital data streams representing various types of information. Further, the communication interface 717 can include peripheral interface devices, such as a Universal Serial Bus (USB) interface, a PCMCIA (Personal Computer Memory Card International Association) interface, etc. Although a single communication interface 717 is depicted in FIG. 7, multiple communication interfaces can also be employed.

The network link 719 typically provides data communication through one or more networks to other data devices. For example, the network link 719 may provide a connection through local network 721 to a host computer 723, which has connectivity to a network 725 (e.g. a wide area network (WAN) or the global packet data communication network now commonly referred to as the “Internet”) or to data equipment operated by a service provider. The local network 721 and the network 725 both use electrical, electromagnetic, or optical signals to convey information and instructions. The signals through the various networks and the signals on the network link 719 and through the communication interface 717, which communicate digital data with the computer system 700, are exemplary forms of carrier waves bearing the information and instructions.

The computer system 700 can send messages and receive data, including program code, through the network(s), the network link 719, and the communication interface 717. In the Internet example, a server (not shown) might transmit requested code belonging to an application program for implementing an embodiment of the invention through the network 725, the local network 721 and the communication interface 717. The processor 703 may execute the transmitted code while being received and/or store the code in the storage device 709, or other non-volatile storage for later execution. In this manner, the computer system 700 may obtain application code in the form of a carrier wave.

The term “computer-readable medium” as used herein refers to any medium that participates in providing instructions to the processor 703 for execution. Such a medium may take many forms, including but not limited to non-volatile media, volatile media, and transmission media. Non-volatile media include, for example, optical or magnetic disks, such as the storage device 709. Volatile media include dynamic memory, such as main memory 705. Transmission media include coaxial cables, copper wire and fiber optics, including the wires that comprise the bus 701. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

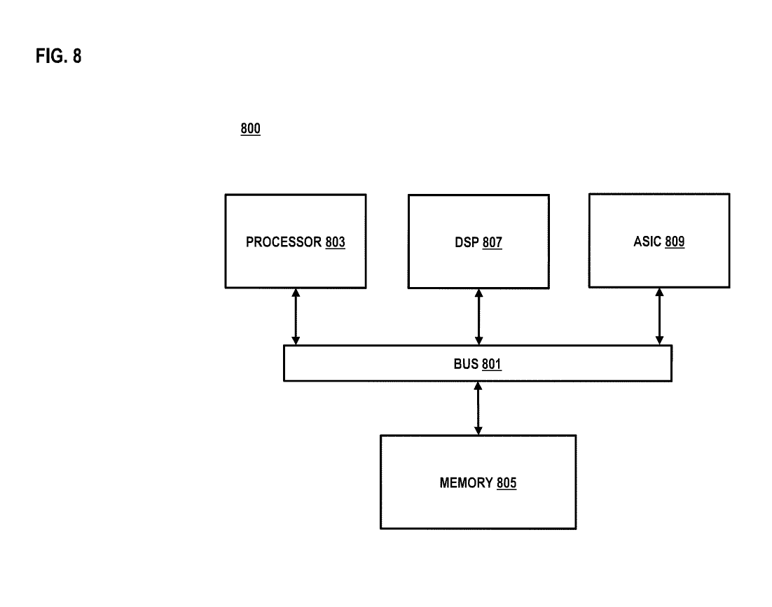

FIG. 8 illustrates a chip set 800 upon which an embodiment of the invention may be implemented. Chip set 800 is programmed to provide for engaging and managing user interactions with product or service notifications at a user device includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 800, or a portion thereof, constitutes a means for performing one or more steps of FIGS. 4 and 5.

In one embodiment, the chip set 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to controlling a set-top box based on device events. The memory 805 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
identifying media content presented in proximity to a device;
presenting an option for interacting with the media content at the device while the media content is presented;
receiving a selection input for initiating the option for interacting with the media content; and
transmitting a report of the selection input, a performance of the option, or a combination thereof to the device, a service provider, or a combination thereof.

2. A method of claim 1, further comprising:
initiating an application at the device based on the media content, a location of the device, or a combination thereof.

3. A method of claim 1, further comprising:
updating a user account, a service provider account, or a combination thereof associated with the device based on the selection input.

4. A method of claim 1, wherein the media content is a trailer for a product, a service, or a combination thereof.

5. A method of claim 1, wherein the selection input is made by scanning a code associated with the media content.

6. A method of claim 1, further comprising:
initiating a notification, an updating of a user schedule, or a combination thereof based on the selection input.

7. A method of claim 1, wherein the option for interacting with the media content includes (a) a purchase of the product, the service, or a combination thereof; (b) an addition of the product, the service, or a combination thereof to a wish-list; or (c) a combination thereof.

8. A method of claim 7, further comprising:
initiating a presentation of a notification at the device, at another device or a combination thereof associated with a user based on the wish-list; and
presenting an option for interacting with the product, the service, or a combination thereof on the wish-list.

9. An apparatus comprising:
a processor; and
a memory including computer program code for one or more programs,
the memory and the computer program code configured to, with the processor, cause the apparatus to perform at least the following:
identify media content presented in proximity to a device;
present an option for interacting with the media content at the device while the media content is presented;
receive a selection input for initiating the option for interacting with the media content; and
transmit a report of the selection input, a performance of the option, or a combination thereof to the device, a service provider, or a combination thereof

10. An apparatus of claim 9, wherein the apparatus is further caused to:
initiate an application at the device based on the media content, a location of the device, or a combination thereof.

11. An apparatus of claim 9, wherein the apparatus is further caused to:
update a user account, a service provider account, or a combination thereof associated with the device based on the selection input.

12. An apparatus of claim 9, wherein the media content is a trailer for a product, a service, or a combination thereof.

13. An apparatus of claim 9, wherein the selection input is made by scanning a code associated with the media content.

14. An apparatus of claim 9, wherein the apparatus is further caused to:
initiate a notification, an updating of a user schedule, or a combination thereof based on the selection input.

15. An apparatus of claim 9, wherein the option for interacting with the media content includes (a) a purchase of the product, the service, or a combination thereof; (b) an addition of the product, the service, or a combination thereof to a wish-list; or (c) a combination thereof.

16. An apparatus of claim 15, wherein the apparatus is further caused to:
initiate a presentation of a notification at the device, at another device or a combination thereof associated with a user based on the wish-list; and
present an option for interacting with the product, the service, or a combination thereof on the wish-list.

17. A system comprising:
a notification platform configured to identify media content presented in proximity to a device; present an option for interacting with the media content at the device while the media content is presented; receive a selection input for initiating the option for interacting with the media content; and transmit a report of the selection input, a performance of the option, or a combination thereof to the device, a service provider, or a combination thereof.

18. A system of claim 17, wherein the notification platform is further configured to initiate an application at the device based on the media content, a location of the device, or a combination thereof.

19. A system of claim 17, wherein the media content is a trailer for a product, a service, or a combination thereof, and wherein the selection input is made by scanning a code associated with the media content.

20. A system of claim 17, wherein the notification platform is further configured to
initiate a presentation of a notification at the device, at another device or a combination thereof associated with a user based on the wish-list; and present an option for interacting with the product, the service, or a combination thereof on the wish-list.
